(19) United States
(12) Patent Application Publication
(10) Pub. No.: US 2017/0083225 A1
(43) Pub. Date: Mar. 23, 2017

(54) CONTEXTUAL MESSAGING RESPONSE SLIDER

(71) Applicant: Cisco Technology, Inc., San Jose, CA (US)

(72) Inventors: Andrew HENDERSON, Spiddal (IE); Keith GRIFFIN, Oranmore (IE)

(21) Appl. No.: 14/859,305

(22) Filed: Sep. 20, 2015

(51) Int. Cl. G06F 3/0488; H04L 12/58; G06F 17/27; G06F 3/0484; G06F 3/0482

(52) U.S. Cl. CPC G06F 3/04883; G06F 3/04845; G06F 3/0482; G06F 17/271; G06F 17/2775; H04L 51/08; H04L 51/046

(57) ABSTRACT

In one embodiment, a method for associating a contextually based limitation with an outgoing communication from a computing device includes: detecting a drag user interface (UI) gesture on a symbol displayed on a display screen associated with the computing device, determining a context for the outgoing communication, based on the determined context, providing a list of input options, progressively displaying the list of input options on the display screen as the drag UI gesture proceeds across the display screen, detecting a release of the drag UI gesture, associating, with the outgoing communication, a most recently displayed input option from among the list of input options as the contextually based limitation, and sending the outgoing communication.

### FIELD OF THE INVENTION

The present invention generally relates to the use of user interface gestures to indicate contextually relevant quantities.

### BACKGROUND OF THE INVENTION

In messaging, collaboration and/or content sharing applications, the ‘Send’ button typically has only one action associated with it, i.e. it results in a message or item being sent to one or more receiving devices. Additional actions, such as, for example, how long a receiving user may view an image being sent, and/or how many views of the image are allowed, typically require setup of one or more parameters prior to sending.

### BRIEF DESCRIPTION OF THE DRAWINGS

The present invention will be understood and appreciated more fully from the following detailed description, taken in conjunction with the drawings in which:

FIG. 1 is a simplified pictorial illustration of an exemplary user interface (UI) gesture input on an application window, constructed and operative in accordance with embodiments described herein;

FIG. 2 is a schematic illustration of a computing device constructed and operative to process the UI gesture of FIG. 1;

FIG. 3 is a flowchart of a process performed by the computing device of FIG. 2; and

FIGS. 4A-C are simplified pictorial illustrations of exemplary user interface gestures input on an application window, constructed and operative in accordance with embodiments described herein.

### DESCRIPTION OF EXAMPLE EMBODIMENTS

### Overview

A method for associating a contextually based limitation with an outgoing communication from a computing device includes: detecting a drag user interface (UI) gesture on a symbol displayed on a display screen associated with the computing device, determining a context for the outgoing communication, based on the determined context, providing a list of input options, progressively displaying the list of input options on the display screen as the drag UI gesture proceeds across the display screen, detecting a release of the drag UI gesture, associating, with the outgoing communication, a most recently displayed input option from among the list of input options as the contextually based limitation, and sending the outgoing communication.

### Detailed Description of Example Embodiments

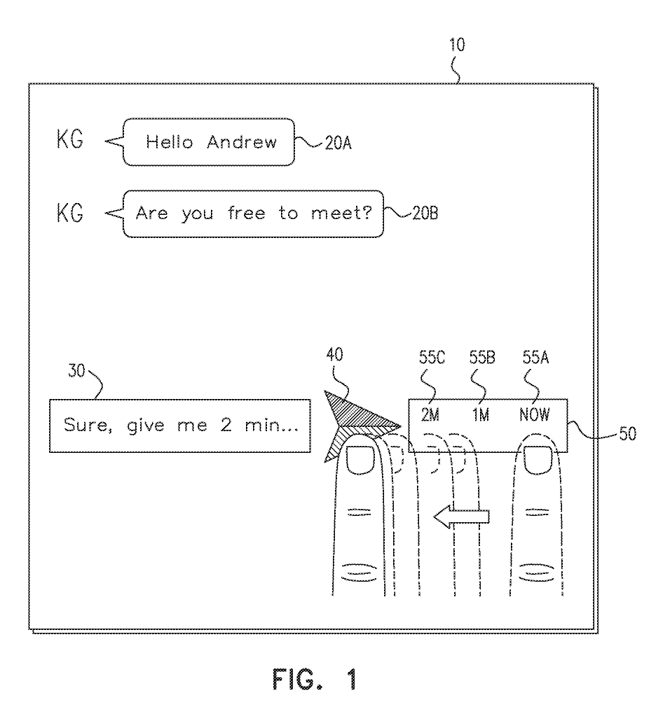

Reference is now made to FIG. 1 which is a simplified pictorial illustration of an exemplary user interface (UI) gesture input on an application window 10, constructed and operative in accordance with embodiments described herein. As depicted in FIG. 1, application window 10 represents an instant messaging (IM) dialogue window between the user of application window 10 and a second user, herein designated as “KG”. It will be appreciated by one of ordinary skill in the art that application window 10 may be implemented within the context of any computer enabled application supporting dialogue between two or more users, such as, for example, IM, email, text messaging, collaboration, social media, etc.

Chat lines 20A and 20B are incoming messages from KG. Chat line 20A represents a greeting sent by KG to the user of application window 10, presumably named “Andrew”, as per the greeting. In chat line 20B KG asks Andrew if he is free to meet. Chat line 30 represents the text of Andrew's response: “Sure, give me 2 min . . . ”

As depicted, send symbol 40 resembles an arrow icon commonly used as a button to send the text of chat line 30 to KG. However, in accordance with embodiments described herein, send symbol 40 may be implemented with additional functionality that may enable the sending user to provide a contextually based limitation to be associated with the outgoing communication. For example, as depicted in FIG. 1, send symbol 40 may be implemented as a sliding pointer to provide some or all of the text input for chat line 30 based on input options 55 in option sliding scale 50. In practice, send symbol 40 may be originally positioned on the right most position of option sliding scale 50, i.e., where input option 55A is shown in FIG. 1.

The user, i.e., Andrew, may select from among input options 55 by pressing and then dragging send symbol 40 to the left. As send symbol 40 is dragged to the left input options 55 may be progressively displayed, such that first input option 55A is displayed, then input option 55B and then input option 55C. When the user breaks contact with send symbol 40, the most recently displayed input option 55 is selected for insertion into chat line 30.

It will be appreciated that input options 55 are ordered according to a progression of temporal values; input option 55A represents “NOW” (i.e., no delay), input option 55B represents a 1 minute delay, and input option 55C represents a two minute delay. Accordingly, send symbol 40 may be viewed as a “catapult” UI gesture; the amount of “tension” applied to the catapult (i.e., the distance that send symbol 40 is dragged), is effectively quantified as an expression of the values provided by input options 55A-C. As will be described hereinbelow, a variety of methods may be used to populate option sliding scale 50 with input options 55 appropriate for insertion into chat line 30.

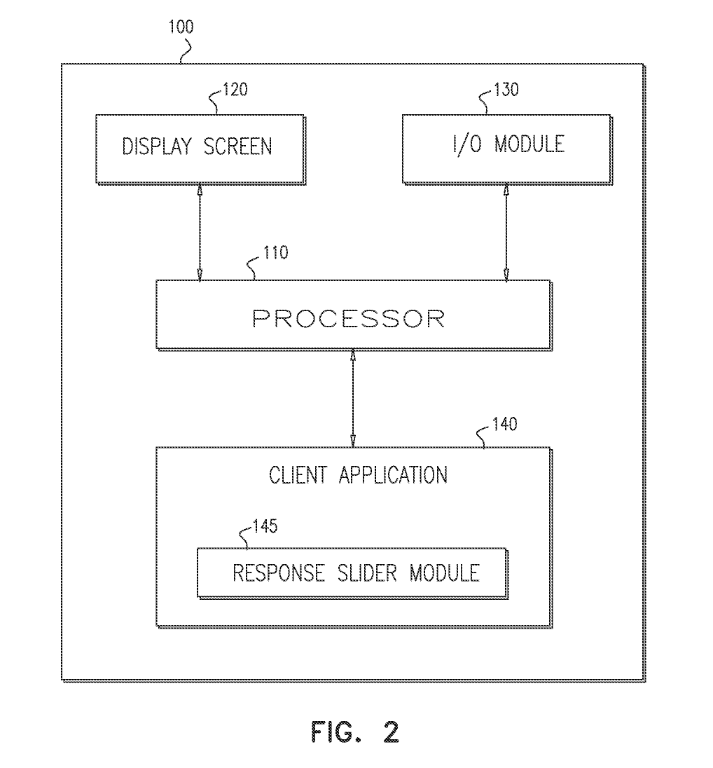

Reference is now made to FIG. 2 which is a schematic illustration of an exemplary computing device 100 constructed and operative to process the UI gesture of FIG. 1. In accordance with embodiments described herein, computing device 100 may be implemented on any communication device suitable to present application window 10, such as, but not limited to, a smartphone, a computer tablet, a personal computer, etc.

It will be appreciated by one of skill in the art that computing device 100 comprises hardware and software components that may provide at least the functionality of application window 10. For example, computing device 100 may comprise at least processor 110, display screen 120, I/O module 130, and client application 140. I/O module 130 may be implemented as a transceiver or similar means suitable for transmitting and receiving data (such as, for example, presented in application window 10) between computing device 100 another device. Display screen 120 may be implemented as a touchscreen to facilitate the input of UI gestures such as shown in FIG. 1. It will be appreciated by one of skill in the art that display screen 120 may also be implemented as a computer monitor or built-in display screen without touchscreen functionality. It will similarly be appreciated that computing device 100 may be configured with alternative means for receiving UI gestures. For example, computing device 100 may also comprise a mouse, pointing device, and/or a keyboard to be used instead of, or in addition to, touchscreen functionality for the input of UI gestures.

It will be appreciated that mobile computing device 100 may comprise more than one processor 110. For example, one such processor 110 may be a special purpose processor operative to execute client application 140. It will be appreciated that client application 140 may be implemented in software and/or hardware. Client application 140 may be any suitable application that may provide functionality similar to application window 10, such as, but not limited to, IM, email, text messaging and/or collaboration applications.

Client application 140 comprises response slider module 145. Response slider module 145 may be implemented in software and/or hardware and may be invoked as necessary by client application 140 to present and process the selection of input options 55 as depicted in FIG. 1.

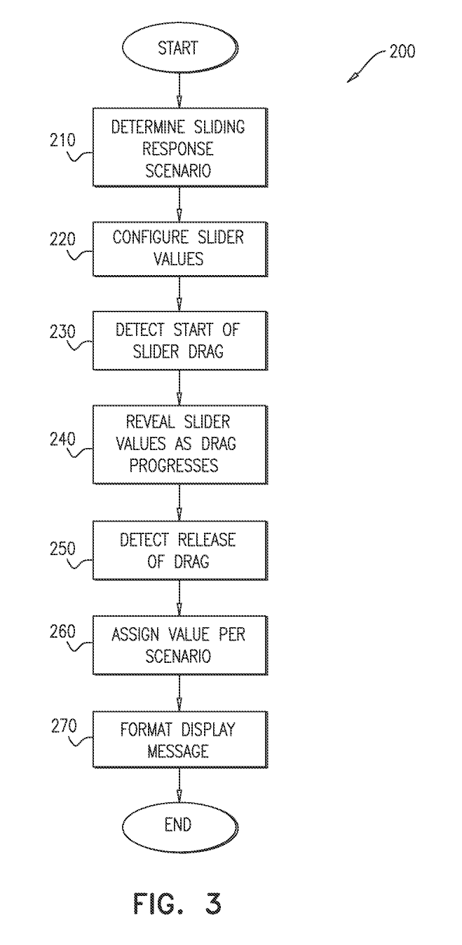

Reference is now made to FIG. 3 which illustrates a contextual messaging response process 200, constructed and operative in accordance with embodiments described herein. Client application 140 may autonomously determine (step 210) a sliding response scenario. In accordance with embodiments described herein, client application 140 may be configured to use one or more of a variety of methods to determine a sliding response scenario. For example, a list of keywords or key phrases may be defined to trigger a given scenario based on the contents of chat lines 20. Per the example of FIG. 1, the word “free” may be defined to contextually trigger a “when can you meet?” scenario. Alternatively, or in addition, the phrase “Are you free?” may be similarly defined to trigger the “when can you meet” scenario. It will be appreciated by one of skill in the art that client application 140 may be configured with a default list of such keywords and/or key phrases. It will similarly be appreciated that such a list may be edited by the user to add additional keywords or key phrases.

Alternatively, or in addition, client application 140 may be configured with a language interpreter module implemented in either hardware and/or software (not shown in FIG. 2), operative to determine the sliding response scenario according to a context in chat lines 20. The language interpreter module may comprise a parsing system to interpret a temporal request and determine the sliding response scenario accordingly. Interpretation may be via a Natural Language Processing engine and/or related techniques. Alternatively, or in addition, a default sliding response scenario may be defined for use with client application 140. For example, regardless of the content of chat lines 20, “when can you meet” may be defined as the default scenario. It will be appreciated by one of skill in the art that the default scenario may be user configurable.

Alternatively, or in addition, client application 140 may be configured to enable the user to specifically select a sliding response scenario. For example, the user may use a menu selection, keystroke command or voice command to select a specific scenario. Client application 140 may also be configured with a learning module implemented in either hardware and/or software (not shown in FIG. 2), and operative to determine the sliding response scenario based on the context of previous user selections.

Client application 140 may invoke response slider module 145 to configure (step 220) values for input values 55 (FIG. 1) as per the context of the sliding response scenario determined in step 210. For example, for a sliding response scenario of “when can you meet”, response slider module may configure values of “Now”, “1 minute” or “2 minutes” respectively for input options 55A, 55B and 55c, as depicted in FIG. 1.

Response slider module 145 may detect (step 230) the start of the slider being dragged by the user. For example, as depicted in FIG. 1, the user may contact display screen 120 with a finger to drag send symbol 40 to the left. Response slider module 145 may progressively reveal (step 240), i.e., display, input options 55 as the dragging progresses.

Response slider module 145 may detect (step 250) the release of the dragging by the user. Response slider module 145 may assign (step 260) a return value based on the most recent input choice revealed, i.e., a contextually based limitation to be associated with the outgoing communication. For example, per the embodiment of FIG. 1, the assigned value may be “2 minutes”. Response slider module 145 may format (step 270) a display message to return to client application 140. For example, per the embodiment of FIG. 1, the value “2 min” may be inserted into the message “Sure, give me X”, where the “X” is replaced by “2 min”. Control may them be returned to client application 140. It will be appreciated by one of skill in the art that some or all of the steps of process 200 may be performed by either client application 140 and/or by response slider module 145; the demarcation of modular functionality may be a design choice when implementing the embodiments described herein.

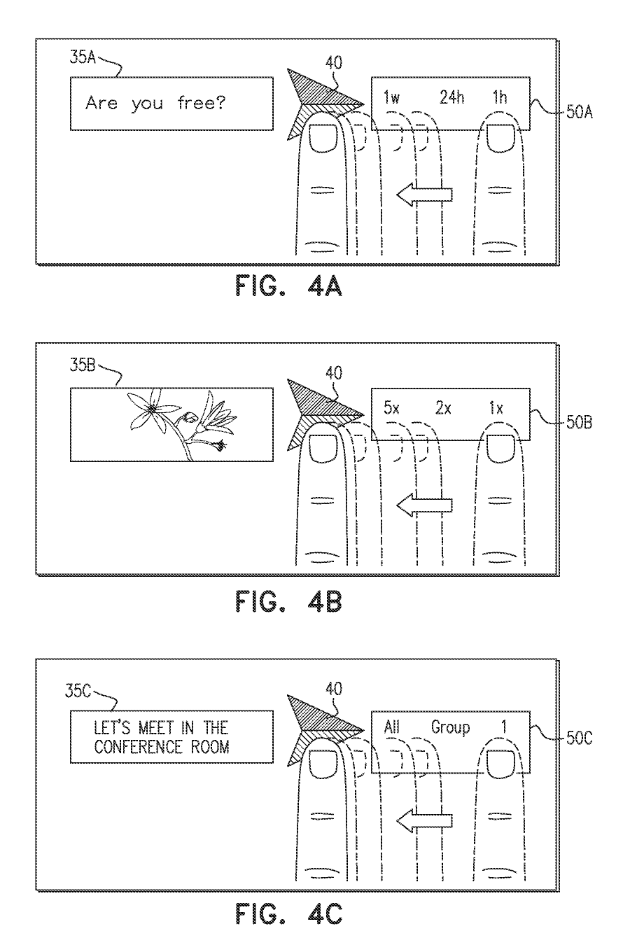

Reference is now made to FIGS. 4A-C, which are simplified pictorial illustrations of how the UI gesture depicted in FIG. 1 may be implemented in multiple contexts, each representing a different sliding response scenario. FIG. 4A depicts a context similar to that of FIG. 1, where trigger 35A, “Are you free?” is analogous to chat line 20B of FIG. 1. Client application 140 in step 210 (FIG. 3) may determine that the sliding response scenario is “when can you meet”. However, it should be noted that a different set of input options 55 may be displayed in option sliding scale 50A. Whereas in FIG. 1 the scale for option sliding scale 50 was expressed in terms of minutes (“now, 1 minute, 2 minutes), in FIG. 4A a different scale is used (1 hour, 24 hours, 1 week). As noted hereinabove, input options 55 (FIG. 1) may be modified in accordance with user preferences and/or actual usage.

It will be appreciated by one of skill in the art that the embodiments described herein may support the provision of contextually based limitations that are not necessarily temporal in nature. For example, per the embodiment of FIG. 4B, the contextually based limitation may be the number of times an image may be viewed. In FIG. 4B trigger 35B is not an incoming message such as trigger 35A, but rather an outgoing image to be transmitted to other devices via I/O module 130 (FIG. 2). Client application 140 may therefore determine that the sliding response scenario is associated with an image sharing context. For such a context, option sliding scale 50B may comprise, for example, a series of values indicating how many times a receiving viewer may view the image being sent. It will, however, be appreciated that in accordance with other embodiments described herein, usage of an image such as being sent in FIG. 4B may be limited contextually by the length of time it may be viewed. To provide such contextual limitation, option sliding scale 50B may comprise, for example, a series of values indicating for how many days, weeks and/or months a receiving viewer may view the image being sent. It will be similarly be appreciated that the embodiments described herein may also support a broader sharing context, i.e., whereas trigger 35B may be specifically identified as an image, an alternative trigger 35 may be another type attachment, such as, for example, a a word processing document. The embodiments described herein may therefore support a trigger of an attachment and/or a type of attachment.

It will be appreciated by one of skill in the art that the embodiments described herein may also support target audience scope as a contextually based limitation. For example, in FIG. 4C trigger 35C is an outgoing meeting invitation to be transmitted to other devices via I/O module 130 (FIG. 2). Client application 140 may therefore determine that the sliding response scenario is associated with a target audience for the invitation. For such a context, option sliding scale 50C may comprise, for example, a series of values indicating who should receive the invitation. Per FIG. 4C, the invitation may be sent to “1” person (i.e., another user with whom the inviting user is currently communicating), a “group” (i.e., a specific group of users associated with an ongoing conversation), or “All” (e.g., all of the inviting user's contacts.

It will be appreciated that client application 140 may be configured to determine a context as a function of an incoming request for action. For example, a meeting invitation may indicate a “confirm attendance” context. For such a context, an exemplary option sliding scale 50 may comprise values such as “yes”, “tentative” and “no”.

It will be appreciated by one of skill in the art that there may be contexts for which more than one option sliding scale may be appropriate. For example, in an image sharing context such as depicted in FIG. 4B, a user may to limit the number of times the image may be viewed; accordingly option sliding scale 50B is expressed in terms of number of times. However, instead of limiting the number of times, the user may alternatively wish to limit for how long the image may be viewed, i.e., express option sliding scale 50B in terms of the duration of time for which the image may be viewed. Accordingly, in accordance with some embodiments described herein, a direction in which send symbol 40 (FIG. 1) is dragged may indicate which scale is to be used. For example, if send symbol 40 is dragged to the left, input options 55 (FIG. 1) may be presented as a progression of time units; if send symbol 40 is dragged to the right, input options 55 (FIG. 1) may be presented as a progression of maximum times to be viewed, e.g., one time, five times, ten times, etc.

It will be appreciated by one of skill in the art that the embodiments described herein provide additional functionality without impacting on how a typical ‘Send’ button works currently. The ‘Send’ button will still be operative to send a message or object to one or more users of a dialogue based application such as, for example, IM, email, text messaging, collaboration, social media, etc. However, in accordance with the embodiments described herein, if the user pulls back the send button (i.e., send symbol 40 in FIG. 1), a range of options will be progressively exposed. Once the desired option is visible, the send button can be released and the desired option will be incorporated into the outgoing message as part of the message itself and/or as a limiting parameter, thereby providing temporal parameters to be set using a simple pull gesture.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method for associating a contextually based limitation with an outgoing communication from a computing device, the method comprising:
detecting a drag user interface (UI) gesture on a symbol displayed on a display screen associated with said computing device;
determining a context for said outgoing communication;
based on said determined context, providing a list of input options;
progressively displaying said list of input options on said display screen as said drag UI gesture proceeds across said display screen;
detecting a release of said drag UI gesture;
associating, with said outgoing communication, a most recently displayed input option from among said list of input options as said contextually based limitation; and
sending said outgoing communication.

2. The method according to claim 1 and wherein said contextually based limitation is a temporal limitation.

3. The method according to claim 1 and wherein said contextually based limitation is a maximum usage limitation.

4. The method according to claim 1 and wherein said contextually based limitation is a target audience scope limitation.

5. The method according to claim 1 and also comprising inserting a textual expression of said contextually based limitation in said outgoing communication.

6. The method according to claim 1 and wherein said determining is based at least in part on a presence of an attachment in said outgoing communication.

7. The method according to claim 6 and wherein said determining: is based at least in part on a type of said document.

8. The method according to claim 1 wherein said symbol is a send symbol.

9. The method according to claim 1 and wherein said determining comprises:
parsing an incoming communication; and
employing a Natural Language Processing engine to determine said context based on said parsed incoming communication.

10. The method according to claim 1 and wherein said determining comprises:
detecting one or more keywords and/or key phrases in an incoming communication; and
determining said context based on said detected one or more keywords and/or key phrases.

11. The method according to claim 1 and wherein said defining comprises:
determining a direction for said drag UI gesture; and
defining said context based at least in part on said direction.

12. The method according to claim 1 and wherein said determining comprises:
defining said context based on a default context.

13. The method according to claim 12 and wherein said defining comprises:
defining said default context on a per application basis.

14. The method according to claim 12 and wherein said defining comprises:
defining said default context based on a request for action.

15. A communication device comprising:
a processor;
a display screen;
an I/O module; and
a client application, said client application executed by said processor and operative to:
send an outgoing communication to other devices via said I/O module,
determine a context for said outgoing communication;
based on said determined context, providing a list of input options;
detect a drag user interface (UI) gesture on a symbol displayed on said display screen,
progressively display said list of input options on said display screen as said drag UI gesture proceeds across said display screen,
detect a release of said drag UI gesture;
associate, with said outgoing communication, a most recently displayed input option from among said list of input options as a contextually based limitation; and
send said outgoing communication in response to said release of said drag UI gesture.

16. The communication device according to claim 15 and wherein said client application is also operative to:
perform said determining based at least in part on the presence of an attachment in said outgoing communication.

17. The communication device according to claim 15 and wherein said display screen is a touchscreen.

18. The communication device according to claim 15 and wherein said symbol is a send symbol.

19. The communication device according to claim 15 and wherein said communication device is a smartphone, a computer tablet or a personal computer.

20. A communication device comprising:
means for detecting a drag user interface (UI) gesture on a symbol displayed on a display screen associated with said computing device;
means for determining a context for said outgoing communication;
means for providing a list of input options based on said determined context;
means for progressively displaying said list of said input options on said display screen as said drag UI gesture proceeds across said display screen;
means for detecting a release of said drag UI gesture;
means for associating, with said outgoing communication, a most recently displayed input option from among said list of input options as said contextually based limitation; and
means for sending said outgoing communication.
